(19) United States
(12) Patent Application Publication
(10) Pub. No.: US 2025/0261581 A1
(43) Pub. Date: Aug. 21, 2025

(54) MINIMAL TILL MANURE APPLICATION UNITS

(71) Applicant: BAZOOKA FARMSTAR, LLC, Washington, IA (US)

(72) Inventors: Jason Bruce Albright, Wellman, IA (US); Justin Michael Graber, Elkhart, IN (US); Chad David Harl, Hedrick, IA (US); Phillip David Minino, Washington, IA (US)

(21) Appl. No.: 19/055,838

(22) Filed: Feb. 18, 2025

Related U.S. Application Data
(60) Provisional application No. 63/555,342, filed on Feb. 19, 2024.

(51) Int. Cl. A01C 15/00

(52) U.S. Cl. CPC A01C 15/001

(57) ABSTRACT

An example manure application unit can include: a main arm pivotally mounted to a toolbar mount tube; a coulter blade operatively connected to the main arm; a closure arm pivotally mounted to the main arm; a closure blade mounted to the closure arm; a main arm downforce assembly, operatively connected between the toolbar mount tube and the main arm, to provide an adjustable downforce force to maintain the coulter blade engaged with ground; and a closure arm torsion spring, operatively connected to the closure arm, to provide varying downforce forces on the closure blade to maintain the closure blade engaged with the ground during operation.

### RELATED APPLICATION(S)

This patent application incorporates U.S. Patent Application No. 63/555,342 filed on Feb. 19, 2024 in its entirety.

### BACKGROUND

The application of manure to a field during tilling can be a complex process. It can require a consistent application of manure at a desired depth to be effective. This requires an applicator that is flexible in terms of operation and adaptable to the specific environment. Further, maintenance of such applicators can be cost-prohibitive and time-consuming.

### SUMMARY

In one aspect, an example manure application unit can include: a main arm pivotally mounted to a toolbar mount tube; a coulter blade operatively connected to the main arm; a closure arm pivotally mounted to the main arm; a closure blade mounted to the closure arm; a main arm downforce assembly, operatively connected between the toolbar mount tube and the main arm, to provide an adjustable downforce force to maintain the coulter blade engaged with ground; and a closure arm torsion spring, operatively connected to the closure arm, to provide varying downforce forces on the closure blade to maintain the closure blade engaged with the ground during operation.

In another aspect, an example method for manure application can include: pivotally mounting a main arm to a toolbar mount tube; operatively connecting a coulter blade to the main arm; pivotally mounting a closure arm to the main arm; mounting a closure blade to the closure arm; providing an adjustable downforce force by a main arm downforce assembly, operatively connected between the toolbar mount tube and the main arm, to maintain the coulter blade engaged with ground; and providing varying downforce forces by a closure arm torsion spring, operatively connected to the closure arm, to maintain the closure blade engaged with the ground during operation.

### DESCRIPTION OF DRAWINGS

FIG. 1 shows an example manure application unit with a spring.

FIG. 2 shows another example manure application unit with a hydraulic cylinder.

FIG. 3 shows example functionality of the manure application unit of FIG. 1.

FIGS. 4A and 4B show example rest and working positions of the manure application unit of FIG. 1.

FIG. 5 shows an example main arm pin assembly of the manure application unit of FIG. 1.

FIG. 6 shows an alternate view of the main arm pin assembly of FIG. 5.

FIG. 7 shows an example closure arm assembly components of the manure application unit of FIG. 1.

FIG. 8 shows an example closure adjustable tension torsion spring system of the manure application unit of FIG. 1.

FIG. 9 shows an example main spring adjustment mechanism of the manure application unit of FIG. 1.

FIGS. 10A and 10B show adjustment of the main spring of the manure application unit of FIG. 1.

FIG. 11 shows an example main spring unit height adjustment system of the manure application unit of FIG. 1.

FIGS. 12A and 12B show example drop tube height adjustment of the manure application unit of FIG. 1.

FIGS. 13A and 13B show example adjustable closure blade positions of the manure application unit of FIG. 1.

FIG. 14 shows example modular design components of the manure application unit of FIG. 1.

FIG. 15 shows an example main blade angle mount of the manure application unit of FIG. 1.

FIG. 16 shows example anti-clog features of the manure application unit of FIG. 1.

FIGS. 17A and 17B show additional anti-clog features of the manure application unit of FIG. 1.

FIG. 18 shows another example manure application unit.

FIG. 19 shows additional details of the manure application unit of FIG. 18.

FIG. 20 shows a portion of the manure application unit of FIG. 19.

### DETAILED DESCRIPTION

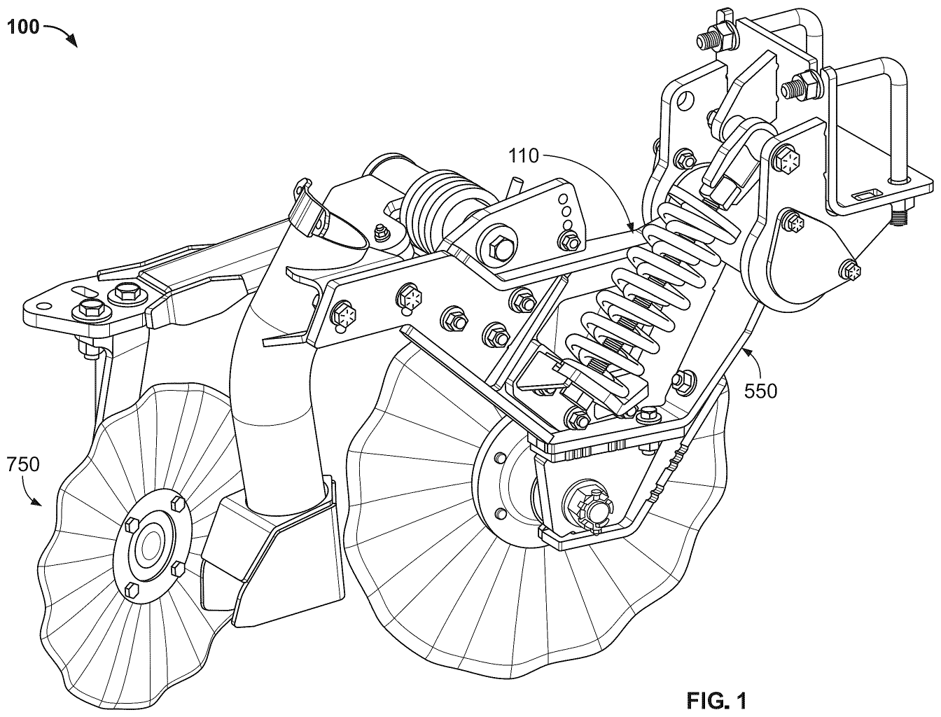

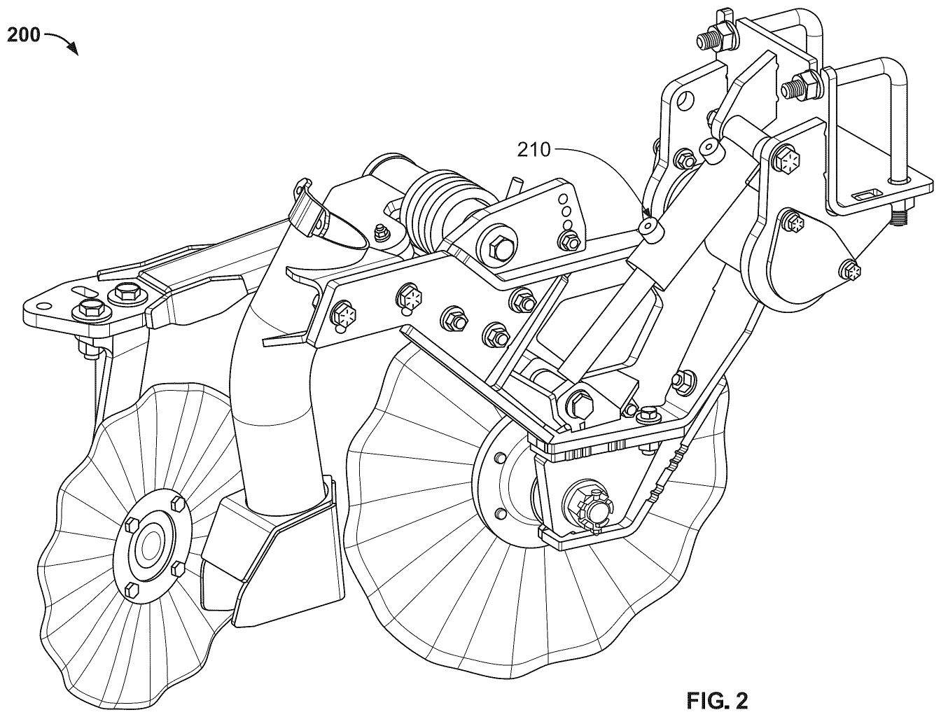

Referring now to FIGS. 1-2, example embodiments of manure application units 100, 200 are shown.

In these examples, each of the manure application units 100, 200 is configured to cut a trench in the ground while moving forward, with the main blade engaging at a consistent depth controlled by the depth gauge ring. As the trench is formed, manure flows continuously through the drop tube into the trench. The closure blade then moves the loose dirt back over the trench to bury the manure, maximizing nutrient uptake by crops and minimizing nutrient loss through volatilization or runoff.

Various coverage improvements can be exhibited by the manure application units described herein. Manure can be buried better and stay in the ground for maximum crop nutrient uptake. The closure arm downforce of the manure application units can stay engaged with the ground to constantly move dirt over the trench without missing areas. The manure application units can include tight fitting, low clearance bushings on all pivots, which have a long wear life. This ensures the blade angles stay consistent, meaning trench size and dirt movement is consistent over the life of the equipment.

In one example, the manure application unit 100 is configured to provide a spring 110 that is configured to create downforce. Further, some of the manure application units, such as the manure application unit 200, provide a hydraulic cylinder 210 to create downforce option to ensure the unit stays engaged fully with the ground at a consistent cutting depth in varying hardness of dirt. Downforce is adjustable by controlling the maximum hydraulic pressure allowed into the cylinder.

Further, the manure application units 100, 200 can include an adjustable closure blade angle and position for varying speeds which ensures the dirt moved by the trench opening main blade is captured and returned overtop the trench once the manure is in the trench. This can include the capability of working with various coulter blade options, which can be changed depending on hard or soft ground, the need for a larger or fully cleaned out trench, wet or dry conditions, or fields with the need to cut or move more crop residue left after harvest.

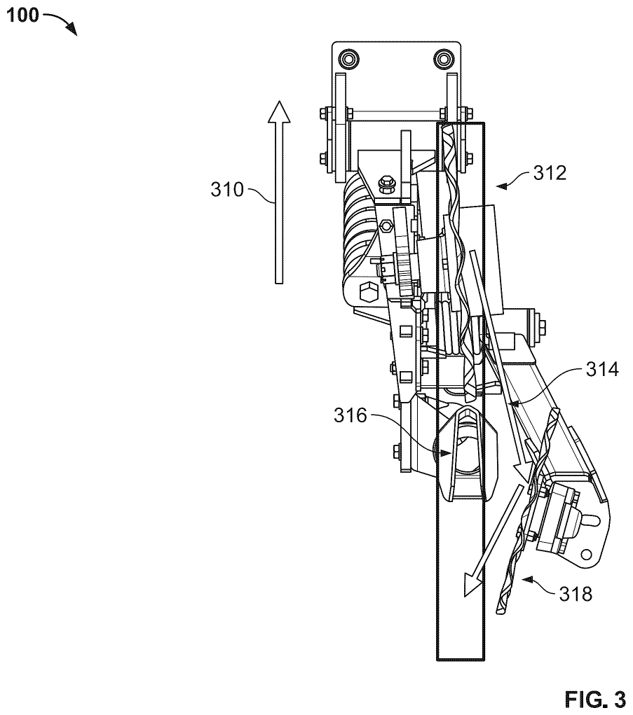

Referring now to FIGS. 3-17B, additional details on the manure application unit 100 including the spring 110 are shown. The manure application unit 200 can be similarly configured.

FIG. 3 illustrates example operation of the manure application unit 100. This includes the key components and their interaction during field operation. The unit travels in a direction 310 while the main blade engages with the ground to cut a trench 312 (schematically referenced) approximately 6 inches deep. As the main blade creates the trench 312, it generates a specific dirt flow path 314 where soil is displaced from the trench and temporarily positioned on top of the ground surface.

The manure delivery system operates continuously during this process, with manure flowing through a drop tube 316 directly into the freshly cut trench 312. This consistent flow ensures uniform manure application throughout the field operation. A closure blade 318, which follows behind the main blade and manure delivery system, moves the previously displaced loose dirt back over the trench 312 containing the manure.

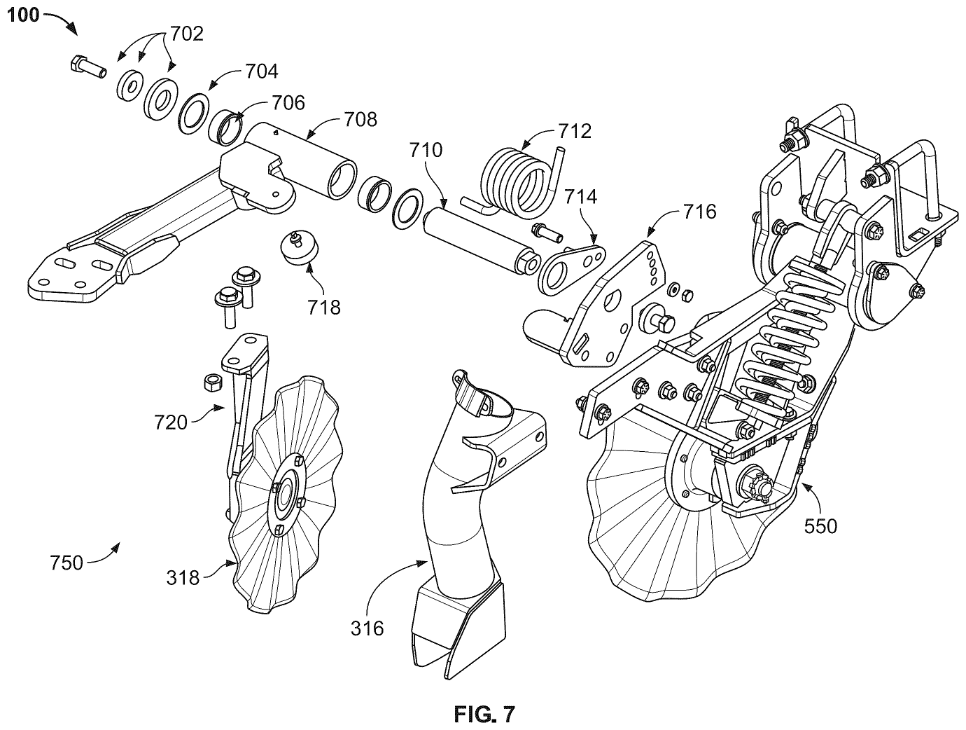

This coordinated sequence of operations—trench cutting, manure application, and trench closure—is designed to optimize nutrient delivery and retention by the manure application unit 100. The process ensures manure is buried properly and remains in the ground, maximizing crop nutrient uptake while minimizing potential nutrient loss. A closure arm assembly 750 (see FIG. 7) maintains consistent downforce engagement with the ground to ensure complete coverage of the trench without missing areas, which is important for proper manure incorporation.

The design allows for various coverage improvements, including better manure burial and consistent trench formation. The blade angles maintain consistency throughout operation, ensuring uniform trench size and dirt movement over the life of the equipment. This systematic approach helps prevent manure exposure to sun and rain, which could otherwise lead to nutrient volatilization or field runoff.

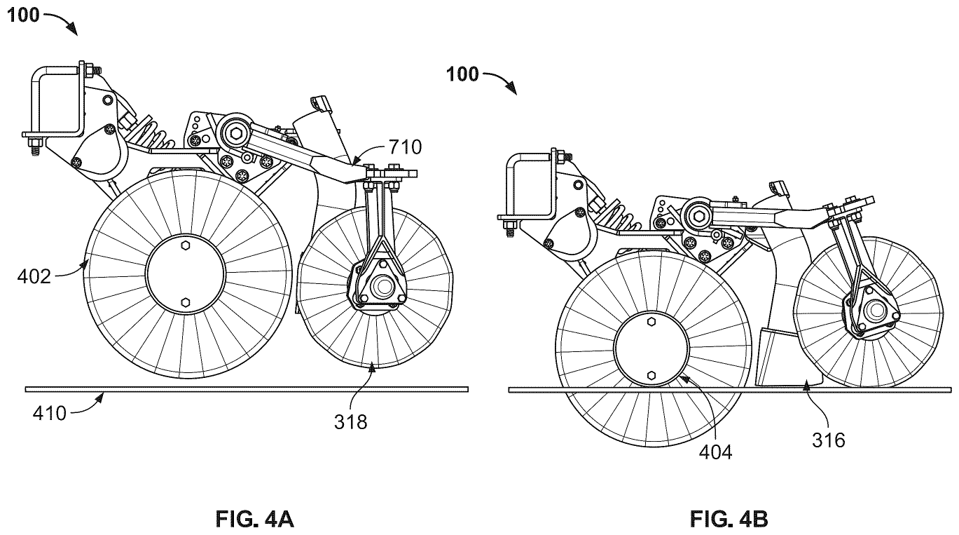

In some examples, the manure application unit 100 provides adjustability for different needs and setups. The downforce spring adjustment mechanism can separately adjust the spring force versus the unit's height or position between the toolbar and ground level 410. See FIGS. 1 and 4A-4B.

More specification, the manure application unit 100 includes both a rest position (FIG. 4A) and a working position (FIG. 4B). In the rest position, when the manure application unit 100 is out of the ground 410, the closure arm assembly 750 rests in a low position against a urethane cushioned down-stop bumper 718. See FIG. 7.

In the working position of FIG. 4B, the manure application unit 100 operates with multiple coordinated components: the main blade 402 engages with the ground 410 to cut the trench, while the closure arm assembly 750 maintains its working position running along the ground surface 410 to push loose dirt back over the trench. During operation, the manure drop tube 316 continuously flows manure into the trench for burial by the closure arm assembly 750.

An example depth control mechanism 404, illustrated as a gauge ring, serves a control function by setting the depth of the trench and preventing the main blade 402 from digging too deep into the soil. This depth control mechanism 404 helps ensure consistent application depth, which is essential for effective manure incorporation and nutrient uptake.

The working position of FIG. 4B demonstrates how the manure application unit 100 maintains consistent engagement with the ground 410 through its downforce system, allowing for proper trench formation and manure application even in varying ground conditions. This design ensures the blade angles stay consistent, resulting in uniform trench size and dirt movement throughout the operational life of the manure application unit 100.

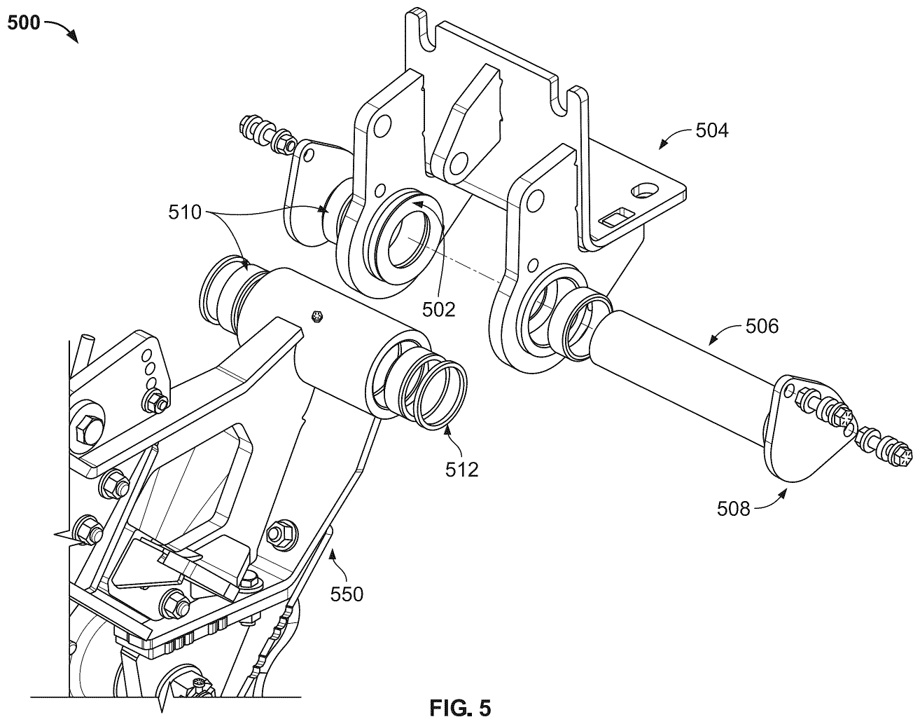

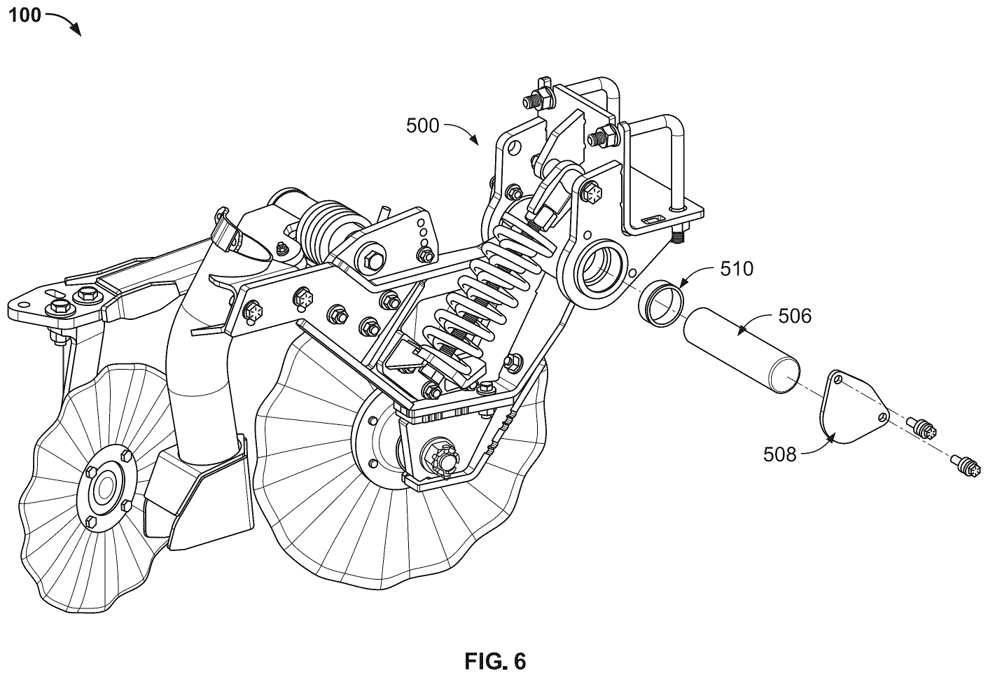

Further, the manure application unit 100 can include fewer wear parts, with each pivot having an option for greaseless maintenance free bushings and simple to manufacture, one piece pins that can be easily replaced. See FIGS. 5-6.

For instance, a detailed illustration of a main arm pin assembly 500 of the manure application unit 100 and its key components designed for maintenance-free operation are shown in FIG. 5. The main arm pin assembly 500 utilizes thrust washers 502 that serve a critical function by preventing direct steel-on-steel contact between a main arm 550 and mount plate, making the thrust washer the primary wear component which is more cost-effective to replace over time.

The design incorporates maintenance-free pin bushings 510 that ensure proper rotation of the main arm relative to both the pin and mount plate without requiring grease. These bushings 510 are engineered to be easily replaceable if wear occurs over time, while preventing any direct contact between steel components that could cause friction and wear to components that are more difficult and costly to replace.

The main arm pin assembly 500 features a floating pin design where the pin can rotate freely while being contained axially between the keeper plates 508. Notably, the pin keeper plates 508 are not directly attached to a pin 506. The main arm rotation pin 506 utilizes a seal system on a mount plate 504 that activates once the pin 506 is inserted through the main arm 50, effectively preventing dirt and moisture from entering the main arm 550 and causing rust over time.

This design focuses on minimizing wear parts, with each pivot having greaseless maintenance-free bushings and simple pins that can be easily replaced. Components that do not pivot utilize bolted joint engagement to minimize the possibility of vibration-induced wear due to inadequate connections.

FIG. 7 illustrates the example closure arm assembly 750 of the manure application unit 100, which functions to control manure application and trench closure. The closure arm assembly 750 is anchored by a closure arm pivot pin 710, which works in conjunction with bushings 706 and thrust washers 704 to enable smooth rotational movement.

A closure arm weldment 708 serves as the main structural component, connecting to a closure arm hub 720 including a closure blade 318. This assembly interfaces with a closure arm spring 712, which provides the necessary downforce for ground engagement. The tension of the closure arm spring 712 is managed through a closure arm tension adjustment plate 714, allowing for variable pressure control, as described further below.

The closure arm weldment 708 incorporates the down-stop bumper 718, which provides a cushioned rest position for the closure arm assembly 750 against a closure mount/down-stop weldment 716 when not engaged with the ground. This component works in concert with the closure keeper washers and bolt to maintain proper assembly alignment and security.

The manure drop tube 316 is positioned near the closure arm assembly 750 to deliver manure directly into the trench. This positioning works in coordination with the closure arm hub 720 and closure blade 318 (formed as a coulter blade) to ensure proper manure placement and subsequent coverage. The closure arm assembly 750 maintains consistent engagement with the ground to constantly move dirt over the trench without missing areas, while the closure arm downforce stays engaged to ensure proper burial of the manure for maximum crop nutrient uptake.

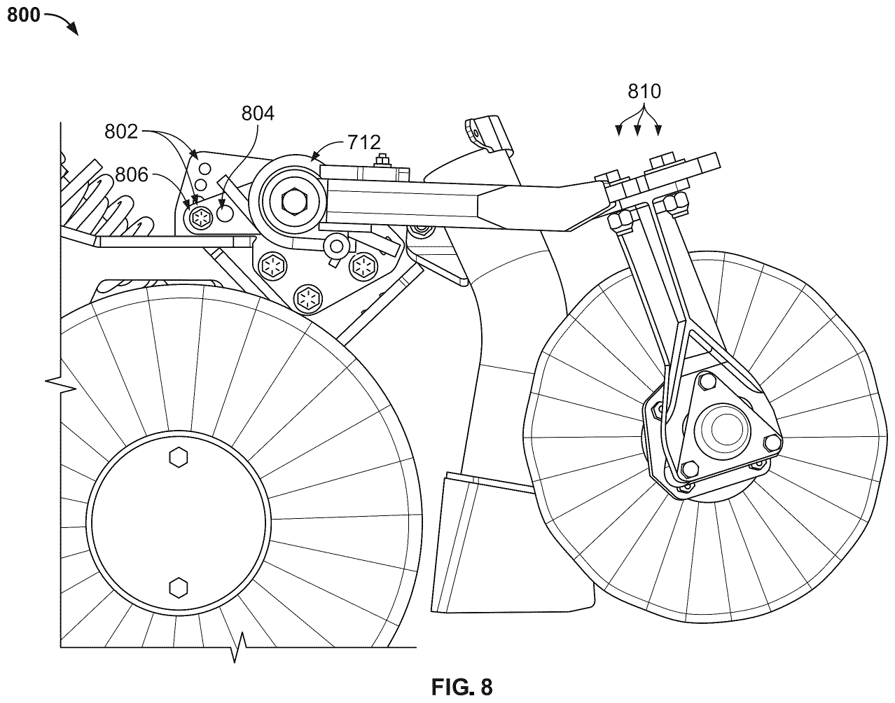

More specifically, as shown in FIG. 8, a closure adjustable tension torsion spring system 800 provides controlled downforce for the closure arm operation. The closure arm torsion spring 712 is designed to engage with a spring stop pin 804 located on the closure tension adjustment plate when the closure arm angle increases above ground level.

In its default position, the spring 712 applies minimal down pressure to the closure arm 750 as it floats freely above the pin. However, if the closure arm 750 bounces upward during operation, the spring 712 functions as a catch mechanism, preventing the closure from pivoting too high before returning to its working position.

The closure adjustable tension torsion spring system 800 features four distinct tension adjustment positions 802 that can be selected using a tension adjustment bolt 806. These positions engage the torsion spring at different closure arm angles, resulting in varying levels of downforce 810 on the closure blade 318. This adjustable downforce capability serves two critical functions: it helps maintain consistent blade engagement with the ground at any operating speed, and it assists with soil displacement in hard ground conditions.

The adjustable downforce feature is particularly important in hard ground conditions where the main blade's soil displacement may be limited due to minimal “shattering” of dirt around the trench. In these situations, the ability to increase closure blade downforce 810 helps displace more dirt over the trench, representing a significant improvement in manure application effectiveness. The spring also acts as an “up stop” catch when the entire unit and closure arm encounters obstacles like rocks, preventing excessive upward movement.

The design incorporates tension adjustment positions 802 clearly marked on the assembly, allowing for precise control of the spring's engagement point. This adjustability ensures the closure blade maintains proper ground contact while effectively moving displaced soil back over the manure-filled trench.

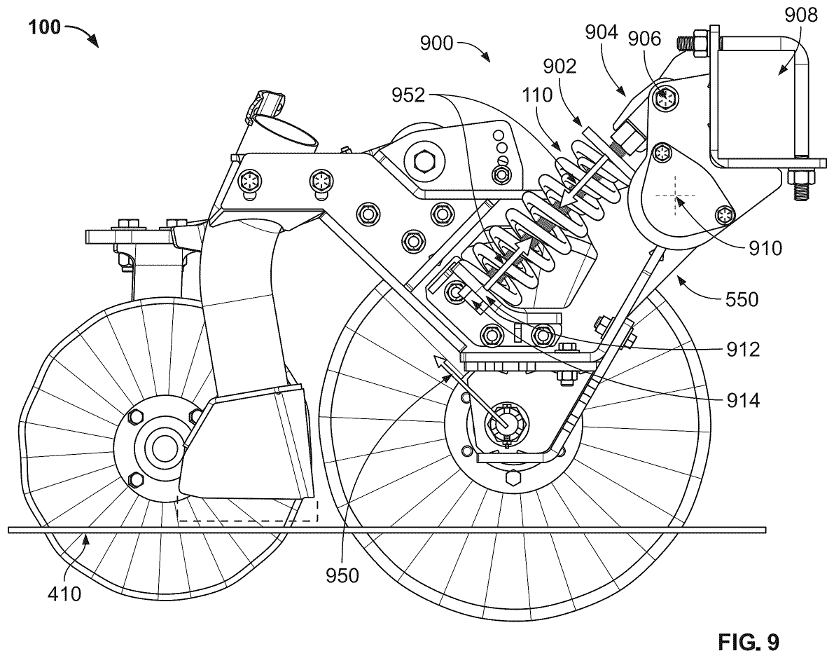

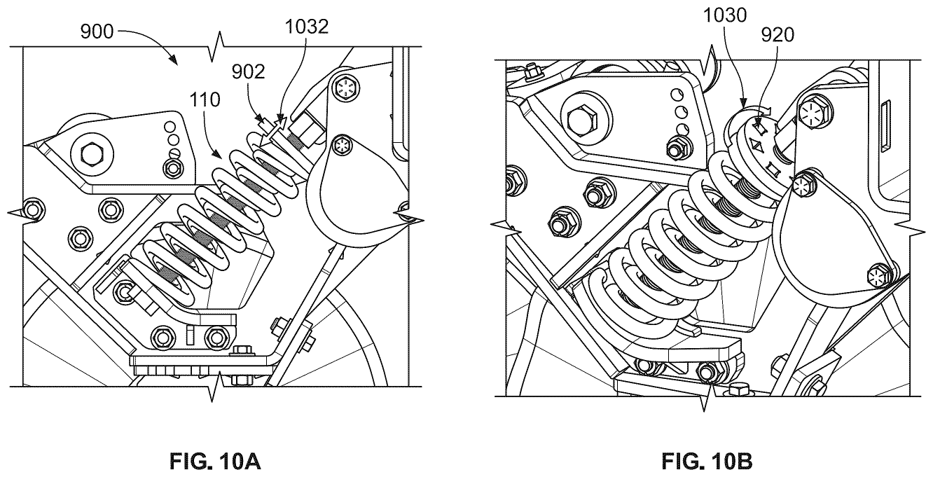

FIGS. 9-10B illustrate a main spring system 900 and its operation. The downforce spring system 900 that maintains prescribed force to keep the main opener blade 402 engaged with the ground 410. The spring 110 of the downforce spring system 900 employs a nested coil spring (one spring inside another to maximize spring loads for the size), though this could be alternatively configured with a hydraulic cylinder, airbag, or equivalent mechanisms.

The system's operation involves several interconnected components: spring mount clevis 904; a spring mount pivot bolt 906; a toolbar mount tube 908; a spring pre-load plate 902; a main arm/main pin axis of rotation 910; a spring lower mount plate 912; and a spring bolt 914.

When the main arm rotates upward in a direction 950 around the main pin axis 910 due to encountering obstacles like hard ground or rocks, it decreases the distance between the spring lower mount plate 912 and the spring pre-load plate 902, compressing the spring 110 in directions 952. During this action, the spring bolt 914 maintains its position while extending out of the spring lower mount plate 912 as the spring compresses.

The spring mount clevis 904 rotates around the spring mount pivot bolt 906 to accommodate the rotating main arm 550. The different rotation points between the spring 110 and the main arm 550 enable the distance reduction between the spring lower mount plate 912 and spring pre-load plate 902 during upward rotation of the main arm 550.

As shown in FIGS. 10A-10B, the spring force can be adjusted by engaging cutouts 920 in the spring pre-load plate 902 with a ½″ ratchet or breaker bar. Rotating the plate 902 around the bolt 906 in directions 1030 moves it up or down in directions 1032, which compresses or decompresses the spring 110 to adjust the force applied to the main arm 550.

A notable design feature is a location of the spring 110 behind the toolbar mount tube 908, which provides greater flexibility for unit spacing options when mounted to a toolbar. The configuration, where only bolts wrap around the front side of the tube, reduces potential interference with toolbar cross tubes.

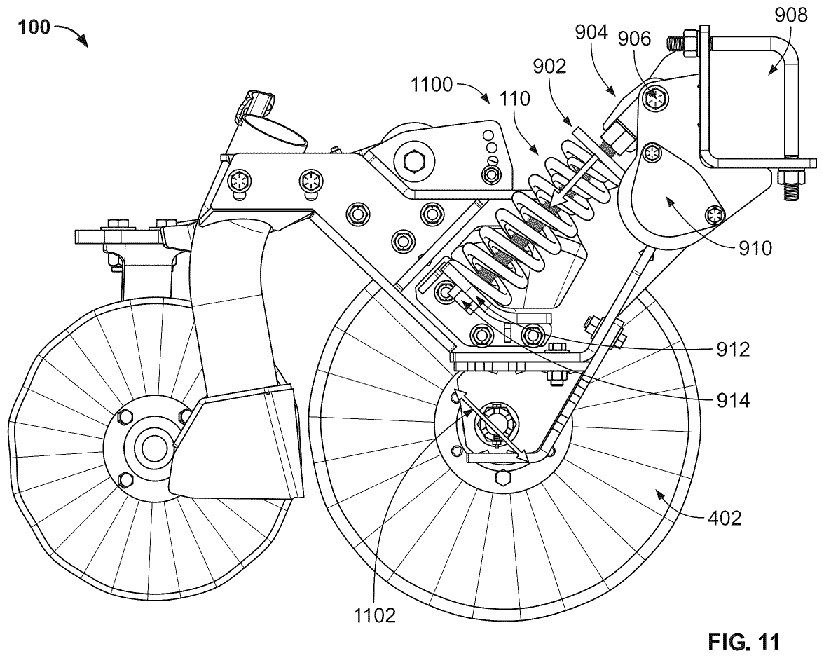

In addition to adjusting the spring tension using the main spring system 900, FIG. 11 illustrates a main spring unit height adjustment system 1100, which operates independently from the main spring system 900. The main spring unit height adjustment system 1100 allows a main arm position (height) relative to the toolbar mount tube 908 to be adjusted separately from the main spring system 900.

This main spring unit height adjustment system 1100 is achieved through the spring bolt 914, which can be tightened or loosened to thread further into or out of the spring mount clevis 904. This action causes the resting position of the main arm 550 to rotate upward or downward in directions 1102 around the main pin axis of rotation 910, effectively changing the height of the main blade 402 relative to the toolbar mount tube 908.

This main spring unit height adjustment system 1100 provides significant benefits for implementing multiple manure injection units across a toolbar. For example, when using 30 individual injection units, this main spring unit height adjustment system 1100 capability helps eliminate variability in manufacturing tolerances that could otherwise result in inconsistent injection depths across units.

A crucial advantage of this design is that the spring tension remains independent of spring height, ensuring that performance of the manure application unit 100 remains consistent regardless of mounting adjustments. This separation of height adjustment from spring tension control allows for precise calibration of both the operating height and downforce pressure, enabling optimal performance across varying field conditions.

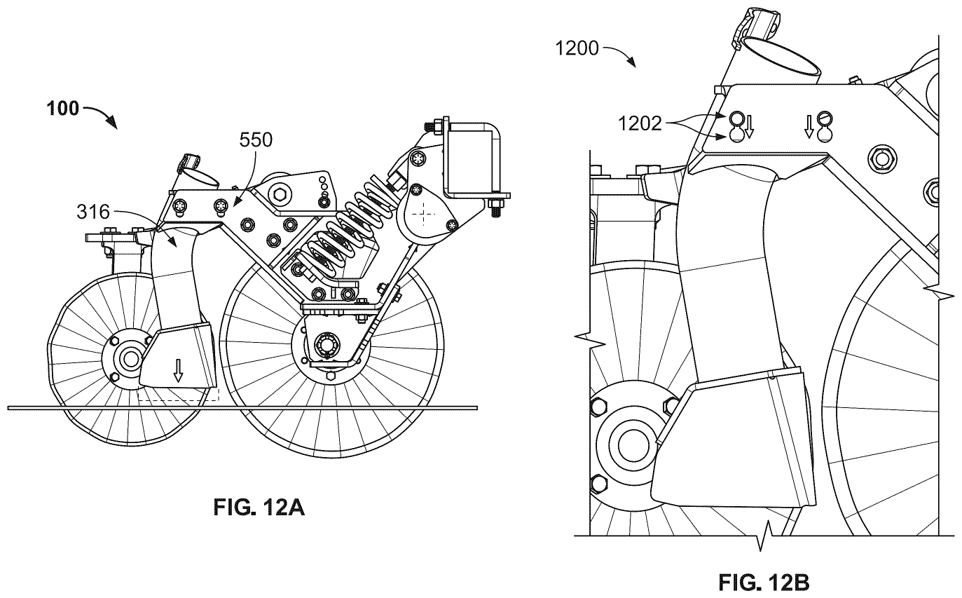

FIGS. 12A-12B illustrate an example drop tube height adjustment system 1200, which addresses the challenge of manure application in varying ground conditions. When encountering hard ground, the main blade 402 may not achieve sufficient depth penetration, causing the manure application unit 100 and associated drop tube 316 to operate higher above ground 410 than desired. This can result in manure splashing out of the trench in the gap between the drop tube 316 and ground level.

The design provides at least two distinct manure drop tube mounting positions 1202 that allow for height adjustment of the drop tube 316 relative to the main arm 550. This adjustability brings the manure outlet closer to the trench, which helps minimize spillage and splashing of manure on top of the ground.

This adjustable drop tube height adjustment system 1200 aligns with the overall purpose of ensuring manure is properly buried in the ground for maximum crop nutrient uptake. The ability to adjust the height of the drop tube 316 helps maintain consistent manure placement even when ground conditions vary, contributing to the system's effectiveness in minimizing nutrient loss through volatilization or runoff.

The drop tube height adjustment system 1200 works in conjunction with other system components of the manure application unit 100 to ensure proper manure application, particularly when the unit encounters varying field conditions that might affect trench depth and manure placement. This adaptability helps maintain the effectiveness of the manure application process across different operating conditions

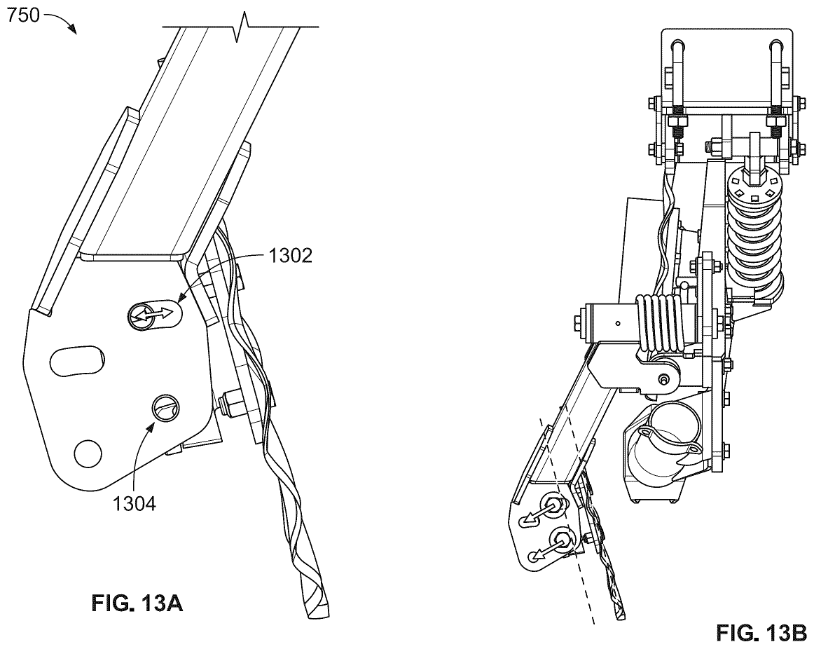

FIGS. 13A-13B illustrate an example adjustable closure blade mount system 1300, which is designed to optimize manure coverage and trench closure through multiple position and angle adjustments. The mount position of the closure blade 318 can be adjusted between at least two different positions and various degrees of rotation, allowing for quick adjustments to properly catch and position loose dirt moved by the main blade back over the manure-filled trench.

The adjustability of the adjustable closure blade mount system 1300 is achieved through two key mechanisms: rotational adjustment using one bolted position that acts as an axis of rotation 1304, while another bolt operates within a slot 1302; and/or position adjustment that allows the closure to be moved outward and bolted in place for a wider operating position

This adaptable design serves several functions. For example, it enables proper coverage of liquid manure in the ground to maximize nutrient uptake by crops. It can also minimize nutrient volatilization from sun exposure and reduce the risk of nutrient runoff from rainfall. The adjustable features are particularly valuable because different operating conditions can affect how soil is displaced during trench formation. These variables include: different main blade options being used; varying operating speeds in the field; and/or different operating angles of the main blade forming the trench.

Since the dirt moved while cleaning the trench may not be thrown to a predictable location relative to the closure, the adjustable angle and position of the closure blade mount allows operators to optimize the closure position based on specific setup requirements. This adjustability ensures maximum performance of the manure injection unit across varying field conditions. The closure blade can be positioned further out and back to catch more dirt during high-speed operation and when using main blades that move more dirt outward to better open the trench

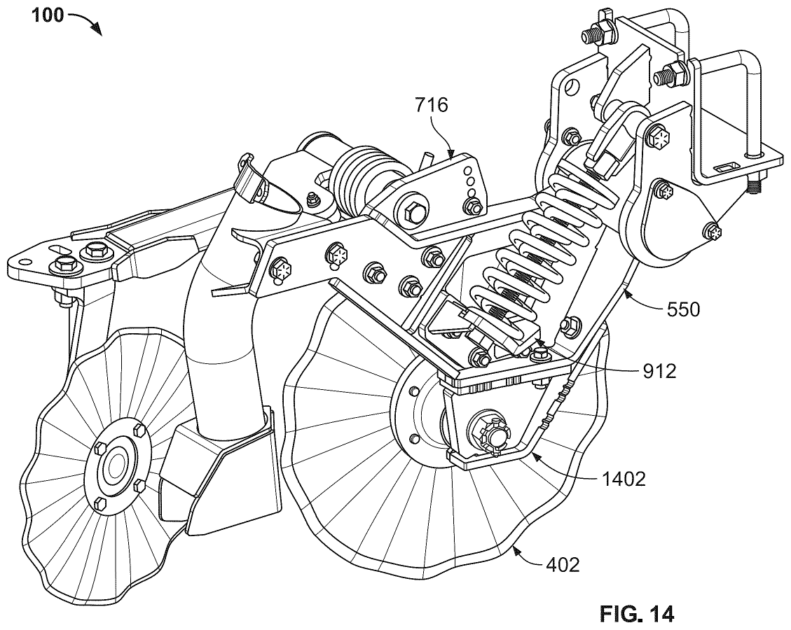

Referring now to FIG. 14, the manure application unit 100 can employ a modular design approach that offers advantages. At the heart of the design is the main arm 550, which serves as the foundation for three critical sub-weldments that can be easily replaced or reconfigured.

The first key component is the closure mount/down-stop weldment 716, which integrates multiple functions into a single replaceable unit. This closure mount/down-stop weldment 716 houses the spring tension adjustment positions and the closure arm down-stop or rest position. Due to its role in mounting the closure arm pin, it experiences significant wear from repeated loading and rotational forces during operation.

The second major component is the spring lower mount plate 912, which plays a crucial role in managing the forces encountered during operation. This spring lower mount plate 912 must withstand substantial loads, particularly when the manure application unit 100 encounters obstacles like rocks that force rapid upward movement. Its modular design allows users to switch between different down-pressure methods without replacing the entire main arm assembly.

The third component is the main blade angle mount 1402, which controls the engagement angle of the main blade 402 with the ground 410. This main blade angle mount 1402 can be manufactured with varying degrees of angle based on specific operating conditions and speeds. In its current configuration, it offers both 3-degree and 5-degree angles from straight, allowing the same main arms to be used across different angle configurations.

This modular approach delivers several key benefits. It reduces customer costs by allowing replacement of individual worn components rather than entire assemblies. For manufacturers, it enables efficient inventory management and quick configuration changes without maintaining large stocks of complete weldments. Additionally, it facilitates future upgrades by allowing new technology or design improvements to be incorporated into smaller sub-components. The design also incorporates bolted joint engagement for non-pivoting components, which helps minimize wear from vibration. This versatility allows the unit to accommodate various tillage tools and fertilizer applicators for year-round use across different operating conditions and application requirements

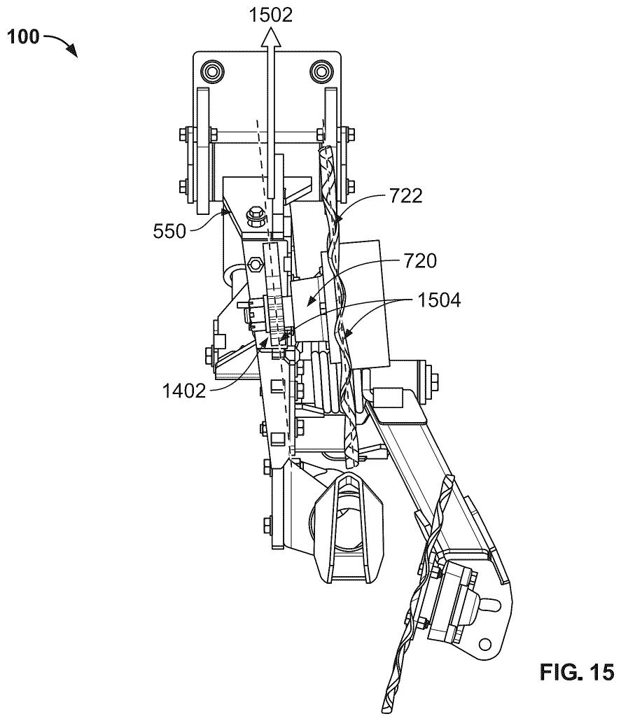

FIG. 15 illustrates additional details of the main blade angle mount 1402, which determines the angle at which the main blade 402 can engage with the ground 450. In some embodiments, the main blade angle mount 1402 may position the main blade 402 at angles such as 3 degrees or 5 degrees relative to the direction of travel, though the main blade angle mount 1402 could potentially accommodate other angle configurations, including negative angles or straight alignment with a travel direction 1502, depending on the specific performance requirements.

In this example, the blade angle could be configured to be parallel to and potentially constrained by the main blade angle mount 1402, which may help provide ground engagement. See notation 1504. This configuration may allow the closure blade 318 to operate across various ground conditions, speeds, and main coulter blade designs.

The spacing between the closure blade 318 and any stationary components may be an important design consideration. In some embodiments, the design could maintain clearance between the main blade 402 and stationary components, which may help allow dirt and crop residue to flow through and away from the application unit rather than potentially causing buildup. Such spacing considerations may align with anti-clog features that could help maintain performance during operation, as described further below.

The main blade angle mount 1402 could represent an element of a modular design approach, potentially allowing main arms to be used for different angle configurations of the manure application unit 100. This adaptability may enable the system to accommodate various operating conditions without requiring complete unit replacement. The main blade angle feature could potentially be adjusted through mechanisms such as hydraulics or other systems, which may provide flexibility in operation and setup.

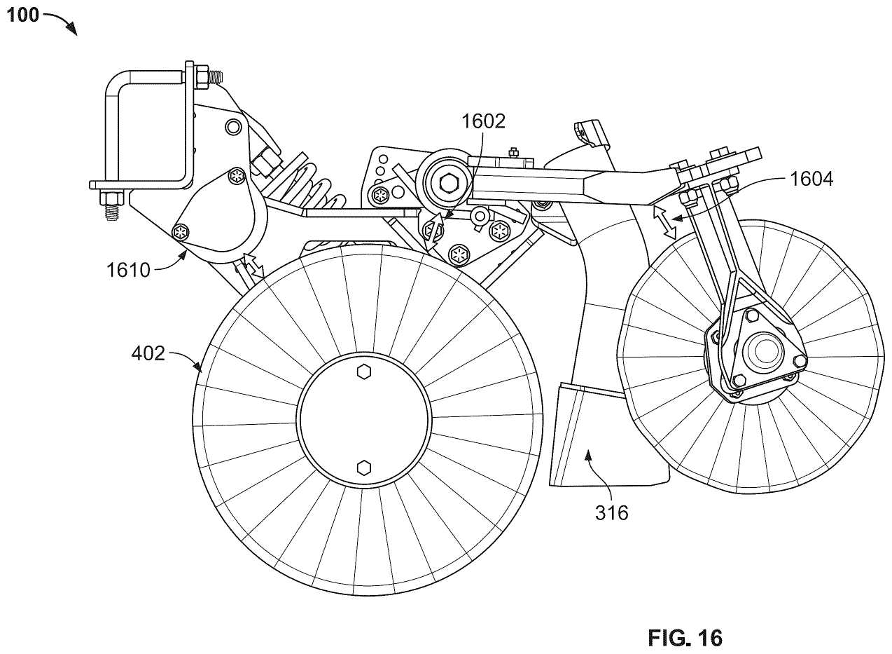

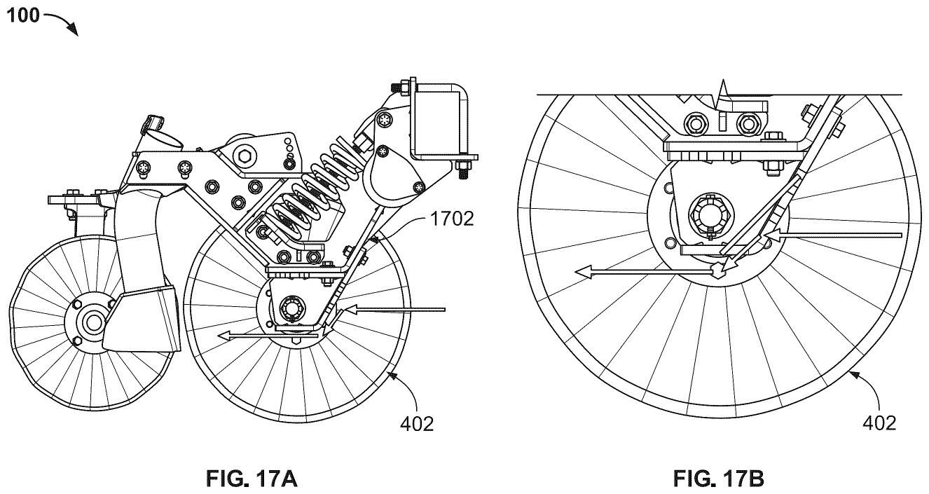

The manure application unit 100 can have anti-clog features as shown in FIGS. 16-17B, including a front leading edge that is tapered to allow crop residue and dirt to flow under the unit to not get trapped and build up in front of the unit when ground engaging. The layout of components (pivot points, blades, and drop tubes) decreases chances for buildup and clogging. See FIGS. 16-17B.

As shown in FIG. 16, the anti-clog features of the manure application unit 100 may include strategic positioning of components that interact with the main blade 402. Components that cross the path of the main blade 402 could be positioned either above at a distance, on the inside of the blade 402, or in front of the main blade 402, which may help minimize the chance for debris and dirt to accumulate and build up.

The design may incorporate specific spacing considerations, such as a gap 1602 between the main blade 402 and the closure pin that crosses above it, which could help prevent material from building up. The closure arm assembly 750 may be set a distance 1604 high above both blades 402, 318, potentially allowing material to flow out from between them, while a mount plate pin 1610 may be positioned in front of the main blade 402.

A configuration of the drop tube 316 could also be designed to allow dirt and crop residue to flow alongside it without becoming pinched between its leading edge and the main blade 402. This arrangement may align with the overall anti-clog features, including a front leading edge that could be tapered to allow crop residue and dirt to flow under the unit rather than potentially getting trapped and building up in front of the manure application unit 100 during ground engagement.

The layout of components, including pivot points, blades, and drop tubes, may be arranged to decrease chances for buildup and clogging. Positioning components behind and lower on the unit could potentially interrupt the flow of material and degrade performance, so the design may avoid such arrangements. This configuration could work in conjunction with other features to help maintain consistent performance during operation across various field conditions.

In FIG. 17A, a leading edge 1702 of the main arm 550 and associated main blade angle mount 1402 are on a back-swept angle to allow crop residue to flow under the unit instead of building up in front of the manure application unit 100. In other embodiments, that backswept angle of the main arm 550 and manure application unit 100 can be even greater, or the angle can vary at different heights to enhance this function even more.

FIG. 17B illustrates another embodiment, in which the main blade angle mount 1402 has a varied angle to allow material to flow underneath the leading edge of the manure application unit 100 more easily. Many other configurations are possible.

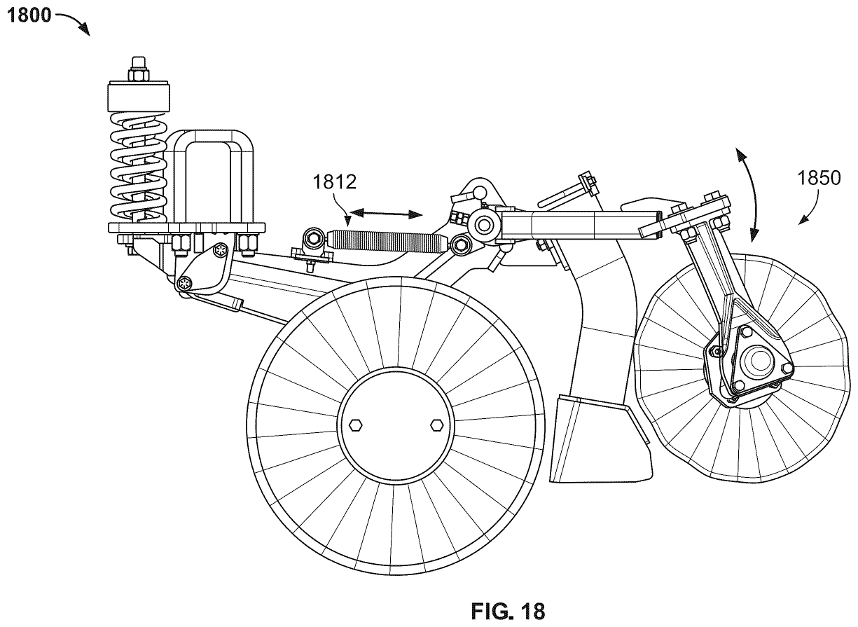

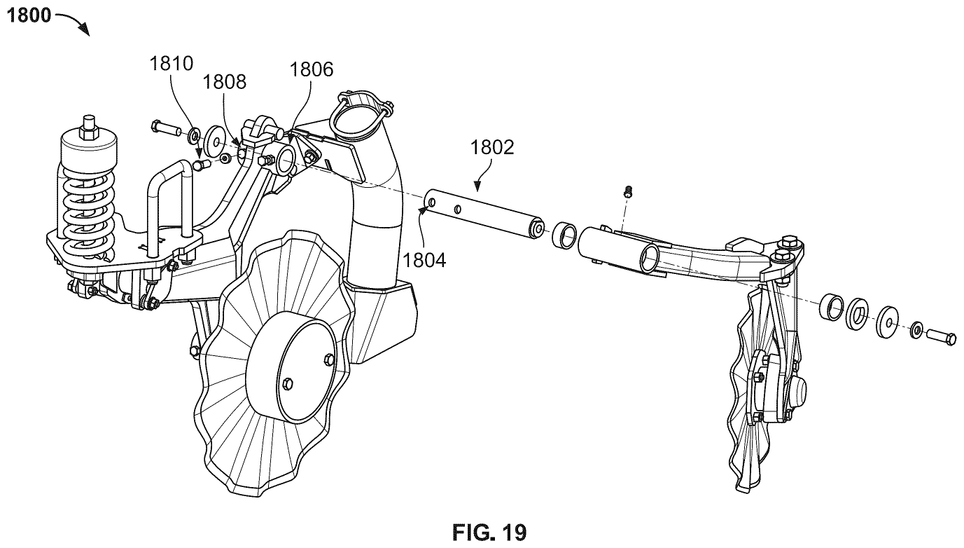

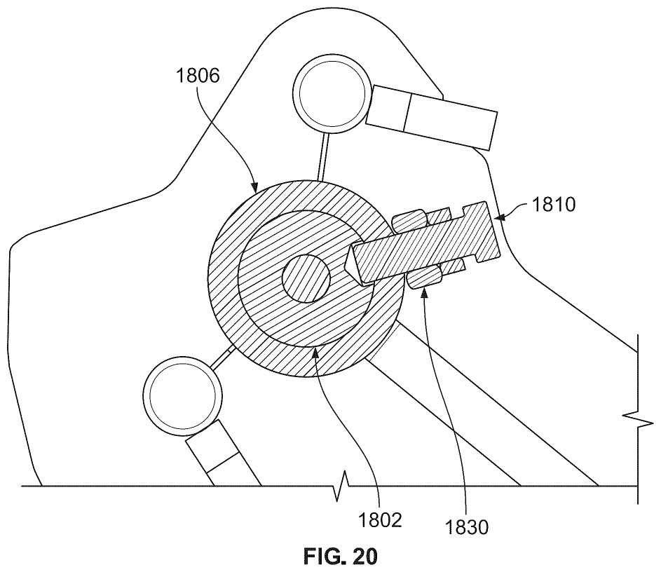

Another embodiment of a manure application unit 1800 is shown in FIGS. 18-20. The manure application unit 1800 is generally configured in a manner similar to the manure application units 100, 300, with the following noted distinctions.

In this example, a closure pivot pin 1802 is inserted into a main arm tube 1806 of the manure application unit 1800 and locked in place. The locking of the closure pivot pin 1802 in place could take on many alternatives, some of which are described herein.

In this embodiment, the closure pivot pin 1802 has at least one blind hole 1804 which, when oriented properly, aligns with a hole 1808 on a main arm tube 1806. At least one set screw 1810 is threaded into a portion of the main arm tube 1806 and then aligns and engages with the blind hole 1804 of the closure pivot pin 1802. In this example, a thread nut 1830 is welded to the main arm tube 1806 are shown in this embodiment as an alternative to drilling and tapping the main arm tube 1806. When the set screw 1810 (or bolts) are tightened into the hole 1808, they ensure the closure pivot pin 1802 can no longer slide side-to-side along the axial direction and keep it from rotating around that same axis. When the bolts are fully tightened, they engage the bottom of the pin's blind hole and clamp the pin against the opposing side of the main arm tube.

The closure pivot pin 1802 can be locked solidly in place to eliminate gaps and clearances between parts, to minimize movement or vibration between the pin and the main arm tube during use, thus eliminating the chances for wear over time. Using the set screw in blind holes, the closure pivot pin can easily be unlocked, disassembled, and replaced if wear or breakage occurs on any portion of the pin. It is desirable to replace a single pin instead of a larger weldment or more complex and expensive component.

The closure pivot pin 1802 can be temporarily locked into place and unable to rotate using alternative means, such as a keyway and key stock, any non-round shapes mate and interlock together to inhibit rotation, bolts acting directly on the pin clamping it in place in various orientations, a tab or flag welded onto the pin to attach to the main arm, etc. Another alternative would be simple cross bolts oriented perpendicular to the mounting tube and pin, locking it from sliding axially, or rotating around its axis. This embodiment may not clamp or lock the pin in a way that eliminates clearances between the pin and mounting tube and introduces the chance for relative movement and wear between the parts.

An example closure arm assembly 1850 of the manure application unit 1800 could use an alternative spring type to apply varying levels of down pressure to the closure blade as it engages the ground, such as an extension spring 1812. Other types of springs, such as a compression spring, leaf spring, compliant joint, hydraulic cylinder, or other energy storage mechanisms can also be used. Spring mounting alternatives may include attachment plates with holes or slots, allowing adjustments to be made to the initial preloaded position of the spring to pre-tension it, or positions that allow leverage to vary in different ways throughout the closure arm rotation. This would allow for closure down-force options to be varied throughout the range of rotation to produce a desired result at certain points in the rotation of the arm.

The manure application units described herein can accommodate different tillage tools and fertilizer applicators for use at all times of year, in wet conditions, running many more acres per year, varying speeds and application requirements, varying ground conditions, alternative materials for decreased wear.

There are alternative embodiments to those shown herein for the manure application units. These can include one or more of (some of these components are discussed above):
hydraulic closing arm with constant down pressure;
adjustable main blade angle, on the fly with hydraulics or other mechanisms (see FIG. 15);
quick release assemblies rather than bolts, which latch into place;
a grease system with automatic greasing of components, including grease reservoirs that could be independent on each individual row unit or combined from one reservoir and distributed to all row units;
hydraulic/pneumatic/electromechanical down pressure for main disc and/or closure arm, the adjustment of which can be controlled manually on the implement's valving, by wired or wireless remote control in the tractor cab, user interface on a tablet computer or tractor ISOBUS system, or the like (see FIGS. 9-11);
down pressure can be changed through various mechanisms on each injection row unit independently, or in sections across the implement, or all having the same down pressure applied equally;
depth control by hydraulic/pneumatic/electromechanical mechanism, which is typically controlled using down pressure but would be managed in such a way that it has position sensing to not go in beyond a certain depth;
depth can be controlled through optical sensing of ground height, smart cylinders, rotary position sensors, or any mechanism known in the art to sense relative position of something;
sensors and a controller to sense how much dirt is flowing past the closure and make position and angle adjustments as necessary to catch more dirt for covering the trench;
sensors (optical, heat signature, etc. to see how much liquid manure is showing above ground after the unit has passed and make automatic adjustments to the injection unit to improve manure coverage and decrease the amount of manure on the ground;
adjustments can be made to the main blade angle, down pressure, closure blade position/angle/down pressure;
sensors to notify operator of maintenance issues, inferior performance issues, clogs in manure hose or clogs from crop chaff/cuttings catching and dragging in the unit;
any pivoting component could incorporate dampening, resisting, and controlling the motion to affect the component's velocity, acceleration, deceleration, stop impact forces, or total travel; and
mechanisms for controlling the motion of a component could be through any type of spring acting on the component, compliant material, hydraulic system, pneumatic system, electromechanical, torque converter, torque limiter, and the like.

It is considered that any bolt-on component of the manure application units could be attached through other mechanisms, whether to allow interchangeability or replacement, allow for prescribed movement, or to be permanently mounted through welding together or casting. Other non-limiting mechanisms of component attachment could include welding, pins and holes or slots, interlocking details, latches, slide engagement, or through any other locking component known in the art to fasten components to one another. Components may also be attached to one another to allow some flexibility rather than having a rigid connection. For instance, the component may be attached through a connecting piece of spring steel, rubber, or other compliant material to allow some movement or flexibility to the connection.

What is claimed is:

1. A manure application unit, comprising:
a main arm pivotally mounted to a toolbar mount tube;
a coulter blade operatively connected to the main arm;
a closure arm pivotally mounted to the main arm;
a closure blade mounted to the closure arm;
a main arm downforce assembly, operatively connected between the toolbar mount tube and the main arm, to provide an adjustable downforce force to maintain the coulter blade engaged with ground; and
a closure arm torsion spring, operatively connected to the closure arm, to provide varying downforce forces on the closure blade to maintain the closure blade engaged with the ground during operation.

2. The manure application unit of claim 1, wherein the main arm downforce assembly includes a spring or a hydraulic unit.

3. The manure application unit of claim 2, wherein the main arm downforce assembly comprises a nested coil spring system having an inner spring positioned within an outer spring to maximize spring loads.

4. The manure application unit of claim 3, wherein the main arm downforce assembly further comprises a spring pre-load plate adjustably mounted on a spring bolt, wherein adjustment of the spring pre-load plate varies spring force independently from unit height.

5. The manure application unit of claim 1, wherein the closure arm torsion spring engages with a spring stop pin mounted on a closure tension adjustment plate, the closure tension adjustment plate having multiple positions for the varying downforce on the closure blade.

6. The manure application unit of claim 5, wherein the closure tension adjustment plate comprises four positions that engage the closure arm torsion spring at different angles of the closure arm to provide different levels of down-pressure on the closure blade.

7. The manure application unit of claim 1, wherein the main arm comprises a modular design having separately attachable components including:
a closure pin mount plate;
a downforce assembly mount plate; and
a main blade angle mount.

8. The manure application unit of claim 7, wherein the downforce assembly mount plate is configured to accommodate interchangeable down-pressure mechanisms including a spring assembly, a hydraulic cylinder, or an airbag.

9. The manure application unit of claim 1, wherein the closure arm torsion spring is configured to act as a catch to stop the closure arm from pivoting beyond a predetermined height when encountering obstacles during operation.

10. The manure application unit of claim 1, further comprising a closure arm pivot pin is insertable into a main arm tube and defines a blind hole, wherein the main arm tube includes a threaded hole aligned with the blind hole of the closure arm pivot pin, and wherein at least one set screw is threaded into the threaded hole to engage the blind hole and lock the closure arm pivot pin against rotation and axial movement.

11. A method for manure application, the method comprising:
pivotally mounting a main arm to a toolbar mount tube;
operatively connecting a coulter blade to the main arm;
pivotally mounting a closure arm to the main arm;
mounting a closure blade to the closure arm;
providing an adjustable downforce force by a main arm downforce assembly, operatively connected between the toolbar mount tube and the main arm, to maintain the coulter blade engaged with ground; and
providing varying downforce forces by a closure arm torsion spring, operatively connected to the closure arm, to maintain the closure blade engaged with the ground during operation.

12. The method of claim 11, wherein the main arm downforce assembly includes a spring or a hydraulic unit.

13. The method of claim 12, wherein the main arm downforce assembly comprises a nested coil spring system having an inner spring positioned within an outer spring to maximize spring loads.

14. The method of claim 13, wherein the main arm downforce assembly further comprises a spring pre-load plate adjustably mounted on a spring bolt, wherein adjustment of the spring pre-load plate varies spring force independently from unit height.

15. The method of claim 11, wherein the closure arm torsion spring engages with a spring stop pin mounted on a closure tension adjustment plate, the closure tension adjustment plate having multiple positions for the varying downforce on the closure blade.

16. The method of claim 15, wherein the closure tension adjustment plate comprises four positions that engage the closure arm torsion spring at different angles of the closure arm to provide different levels of down-pressure on the closure blade.

17. The method of claim 11, wherein the main arm comprises a modular design having separately attachable components including:
a closure pin mount plate;
a downforce assembly mount plate; and
a main blade angle mount.

18. The method of claim 17, wherein the downforce assembly mount plate is configured to accommodate interchangeable down-pressure mechanisms including a spring assembly, a hydraulic cylinder, or an airbag.

19. The method of claim 11, wherein the closure arm torsion spring is configured to act as a catch to stop the closure arm from pivoting beyond a predetermined height when encountering obstacles during operation.

20. The method of claim 11, further comprising inserting a closure arm pivot pin into a main arm tube and defines a blind hole, wherein the main arm tube includes a threaded hole aligned with the blind hole of the closure arm pivot pin, and wherein at least one set screw is threaded into the threaded hole to engage the blind hole and lock the closure arm pivot pin against rotation and axial movement.
